(19) United States
(12) Patent Application Publication
(10) Pub. No.: US 2026/0286117 A1
(43) Pub. Date: Sep. 24, 2026

(54) PVC hose with soft touch effect, as well as method of manufacturing thereof

(71) Applicant: FITT S.p.A., Sandrigo (VI) (IT)

(72) Inventors: Luca Battaglia, Bassano del Grappa (VI) (IT); Gianfranco Battaglin, Marostica (VI) (IT); Annachiara Moro, Thiene (VI) (IT)

(21) Appl. No.: 19/470,030

(22) PCT Filed: Apr. 10, 2024
(86) PCT No.: PCT/IB2024/053488

§ 371 Date: Sep. 27, 2025

(30) Foreign Application Priority Data
Apr. 21, 2023 (IT) 102023000007848

(51) Int. Cl. C08L 27/06; B29C 48/09; B29C 48/21; B29K 27/06; B29K 105/00; B29L 23/00; B32B 1/08; B32B 5/02; B32B 27/12; B32B 27/22; B32B 27/30; C08J 3/20; F16L 11/08

(52) U.S. Cl. CPC C08L 27/06; B29C 48/09; B29C 48/21; B32B 1/08; B32B 5/02; B32B 27/12; B32B 27/22; B32B 27/304; C08J 3/203; F16L 11/08; B29K 2027/06; B29K 2105/0038; B29K 2105/0044; B29K 2995/007; B29K 2995/0087; B29K 2995/0097; B29L 2023/005; B32B 2307/536; B32B 2307/554; B32B 2307/7376; B32B 2597/00; C08J 2327/06; C08J 2427/06; C08L 2201/08; C08L 2205/025; C08L 2205/06

(57) ABSTRACT

A plasticized thermoplastic PVC compound used for manufacturing at least one layer of a flexible or spiraled hose for transporting fluids includes (A) a suspended PVC matrix having (A1) 20-40% by weight of PVC with a K factor measured according to the DIN EN ISO 1628-2 standard greater than 95, and (A2) 20-40% by weight of PVC with a K factor measured according to the DIN EN ISO 1628-2 standard between 65 and 80; (B) 18%-45% by weight of at least one plasticizing agent; (C) 0.5-1% by weight of at least one stabilizing agent; (D) 1.5-4% by weight of at least one co-stabilizing agent; and (E) 0-10% by weight of at least one additive.

### FIELD OF THE INVENTION

The present invention relates to the technical field of flexible or spiralled hoses, and it relates in particular to the use of a plasticised PVC compound for manufacturing at least one layer of a flexible or spiralled hose with a soft touch effect, a method for manufacturing such hose, as well as a flexible or spiralled hose with at least one layer made of such compound.

### Definitions

In the present document, the expression “soft touch” referring to a layer of hose and/or to a compound for providing the latter, is used to indicate the particular and characteristic silky and flowy feeling perceived to touch.

In the present document, the expression “PVC matrix” and its derivatives is used to indicate any resin or mixture of resins containing or consisting of polyvinyl chloride.

In the present document, the expression “plasticising agent” and the derivatives thereof is used to indicate a compound or a mixture of compounds which can increase the flexibility, processability and softness of the polymer in which it is embedded. A plasticising agent may reduce the viscosity of the mixture, lower the phase transition temperatures of the second order, and the elastic modulus of the product.

In the present document, the expression “stabilising agent” and its derivatives is used to indicate a compound or a mixture of compounds which can intercept small molecules resulting from the degradation of the polymer, for example HCl, to form a more stable intermediate compound.

In the present document, the expression “additive” and the derivatives thereof is used to indicate a substance which, when added to a compound, improves one or more characteristics thereof.

In the present document, the expression “filler” and its derivatives is used to indicate solid materials made of particles or fibrosis, substantially chemically inert, with the function of fillers.

### State of the Art

Flexible and spiralled hoses made of plasticized PVC are known.

The former generally have one or more tubular layers made of plasticized PVC and may or may not comprise one or more textile reinforcement layers, generally knitted or cross-hatched. This type of hose has various uses, for example transportation of water for irrigating gardens and/or plants.

The spiralled hoses generally have a main body made of plasticised PVC in which a reinforcement spiral, normally made of rigid PVC, is embedded. This type of hose is generally used for the transportation of water in swimming pool or SPA facilities.

On the other hand, flexible hoses made of rubber, for example of the NBR, SBR type or the like are known.

However, despite being particular silky to touch, such rubber hoses are particularly expensive, heavy and have significant environmental impact.

### SUMMARY OF THE INVENTION

The object of the present invention is to overcome the drawbacks outlined above by providing a flexible and/or spiralled hose with a particular silkiness and flowability to touch.

Another object of the invention is to provide a hose that is particularly cost-effective.

A further object of the invention is to provide a hose with good physical properties.

Another object of the invention is to provide a hose with good mechanical properties.

A further object of the present invention is to provide a hose that is particularly easy to handle.

Another object of the present invention is to provide a hose that is particularly light.

These and other objects which will be more apparent hereinafter, are attained using a plasticised PVC compound for obtaining at least one layer of a flexible and/or spiralled hose and/or by a flexible hose having at least one layer made of such compound and/or by a spiralled hose having a main body with at least one layer made of such compound and/or by a respective method for manufacturing such hoses as described, illustrated and/or claimed herein.

Generally, according to the invention, the plasticised thermoplastic PVC compound may consist of:
(A) a suspended PVC matrix consisting of:
   (A1) 20-40% by weight of PVC having a K factor measured according to the DIN EN ISO 1628-2 standard greater than 95, and preferably greater than 98;
   (A2) 20-40% by weight of PVC having a K factor measured according to the DIN EN ISO 1628-2 standard comprised between 65 and 80, and preferably between 70 and 75;
(B) from 18% by weight to 45% by weight of at least one plasticising agent;
(C) from 0.5% by weight to 1% by weight of at least one stabilising agent;
(D) from 1.5% by weight to 4% by weight of at least one co-stabilising agent;
(E) from 0% by weight to 10% by weight of at least one additive.

The percentages mentioned above are calculated with respect to the total weight of the thermoplastic compound and the total sum of the components from (A) to (E) is 100%.

Furthermore, as known, the K value is a dimensionless index which can be directly related to the molecular weight of a PVC resin and it is used to compare various types of PVC resins.

In a preferred but non-exclusive embodiment, the plasticised thermoplastic PVC compound may consist of:
(A) a suspended PVC matrix consisting of:
   (A1) at least 20% by weight of PVC having a K factor measured according to the DIN EN ISO 1628-2 standard greater than 95, and preferably greater than 98;
   (A2) at least 20% by weight of PVC having a K factor measured according to the DIN EN ISO 1628-2 standard comprised between 65 and 80, and preferably between 70 and 75;
(B) from 18% by weight to 45% by weight of at least one plasticising agent;
(C) from 0.5% by weight to 1% by weight of at least one stabilising agent;
(D) from 1.5% by weight to 4% by weight of at least one co-stabilising agent;
(E) from 0% by weight to 10% by weight of at least one additive.

The percentages mentioned above are calculated with respect to the total weight of the thermoplastic compound and the total sum of the components from (A) to (E) is 100%.

In a further embodiment, the plasticised thermoplastic PVC compound may consist of:
(A) a suspended PVC matrix consisting of:
   (A1) 20-40% by weight of PVC having a K factor measured according to the DIN EN ISO 1628-2 standard greater than 95, and preferably greater than 98;
   (A2) 20-40% by weight of PVC having a K factor measured according to the DIN EN ISO 1628-2 standard comprised between 65 and 80, and preferably between 70 and 75;
(B) from 18% by weight to 45% by weight of at least one plasticising agent;
(C) from 0.5% by weight to 1% by weight of at least one stabilising agent;
(D) from 1.5% by weight to 4% by weight of at least one co-stabilising agent;
(E) from 0.1% by weight to 10% by weight of at least one additive.

The percentages mentioned above are calculated with respect to the total weight of the thermoplastic compound and the total sum of the components from (A) to (E) is 100%.

In a further embodiment, the plasticised thermoplastic PVC compound may consist of:
(A) a suspended PVC matrix consisting of:
   (A1) at least 20% by weight of PVC having a K factor measured according to the DIN EN ISO 1628-2 standard greater than 95, and preferably greater than 98;
   (A2) at least 20% by weight of PVC having a K factor measured according to the DIN EN ISO 1628-2 standard comprised between 65 and 80, and preferably between 70 and 75;
(B) from 18% by weight to 45% by weight of at least one plasticising agent;
(C) from 0.5% by weight to 1% by weight of at least one stabilising agent;
(D) from 1.5% by weight to 4% by weight of at least one co-stabilising agent;
(E) from 0.1% by weight to 10% by weight of at least one additive.

The percentages mentioned above are calculated with respect to the total weight of the thermoplastic compound and the total sum of the components from (A) to (E) is 100%.

In a different preferred but not exclusive embodiment, the plasticised thermoplastic PVC compound may consist of:
(A) a suspended PVC matrix consisting of:
   (A1) 20% by weight of PVC having a K factor measured according to the DIN EN ISO 1628-2 standard greater than 95, and preferably greater than 98;
   (A2) 20% by weight of PVC having a K factor measured according to the DIN EN ISO 1628-2 standard comprised between 65 and 80, and preferably between 70 and 75;
(B) 45% by weight of at least one plasticising agent;
(C) 1% by weight of at least one stabilising agent;
(D) 4% by weight of at least one co-stabilising agent;
(E) 10% by weight of at least one additive.

In another preferred but not exclusive embodiment, the plasticised thermoplastic PVC compound may consist of:
(A) a suspended PVC matrix consisting of:
   (A1) 40% by weight of PVC having a K factor measured according to the DIN EN ISO 1628-2 standard greater than 95, and preferably greater than 98;
   (A2) 40% by weight of PVC having a K factor measured according to the DIN EN ISO 1628-2 standard comprised between 65 and 80, and preferably between 70 and 75;
(B) 18% by weight of at least one plasticising agent;
(C) 0.5% by weight of at least one stabilising agent;
(D) 1.5% by weight of at least one co-stabilising agent;
(E) 0% by weight of at least one additive.

In a further preferred but not exclusive embodiment, the plasticised thermoplastic PVC compound may consist of:
(A) a suspended PVC matrix consisting of:
   (A1) 30% by weight of PVC having a K factor measured according to the DIN EN ISO 1628-2 standard greater than 95, and preferably greater than 98;
   (A2) 30% by weight of PVC having a K factor measured according to the DIN EN ISO 1628-2 standard comprised between 65 and 80, and preferably between 70 and 75;
(B) 32% by weight of at least one plasticising agent;
(C) 0.7% by weight of at least one stabilising agent;
(D) 2.3% by weight of at least one co-stabilising agent;
(E) 5% by weight of at least one additive.

In each embodiment described above, which reports formulations of the compound adapted to obtain the soft touch effect, the components mentioned above (A1) and (A2) may be present in the compound in a mutual ratio of 1:1, for example as in the samples A, B, C, L, O, Q, R, T, U of the example mentioned below 1.

Such solution may allow to obtain an excellent soft touch effect.

In the plasticised PVC compound mentioned above there may be used per se known plasticisers (B), for example DINP, DOTP, TOTM, DIDP, polymeric plasticisers, DOA, DEHA, DIDA, DINCh®, vegetable plasticisers (epoxidized methyl esters) or the like or a mixture of two or more thereof.

Preferably, in the plasticised PVC compound there may be used any type of per se known stabilising agent for example of the type Ca—Zn, Ba—Zn, organic Ca.

A suitable co-stabiliser may be epoxidized soybean oil, which may act synergistically with the stabiliser.

In the aforementioned plasticised PVC compound, any type of additive of the per se known type may be used, for example external and/or internal lubricants, heat stabilisers, UV stabilisers, pigments, antioxidants, antimicrobials, release agents, fungicides, antibacterial agents, process adjuvants, antistatic agents, fillers.

Where present, in the aforementioned plasticised PVC compound, any type of per se known filler may be used, for example calcium carbonate, kaolin, talc, mica, feldspar, wollastonite, natural silica, ceramic or glass microbeads, fibres or a vegetable filler according to the disclosures of application EP10003776.1.

A suitable lubricant may be Paraloid K-125 ER (DOW) and/or Paraloid K-175 (DOW).

Preferably, the compound mentioned above may have a Shore A hardness measured according to the UNI EN ISO 868 standard comprised between 51 Sh A and 89 Sh A, preferably comprised between 60 Sh A and 75 Sh A.

In a preferred but non-exclusive embodiment, the compound mentioned above may have a Shore A hardness measured according to the UNI EN ISO 868 standard comprised between 60 Sh A and 75 Sh A.

Furthermore, the compound may have a resistance to abrasion according to the UNI EN ISO 5470-1 standard in terms of weight loss of the layer, per se known method, of 100-150 mg, more preferably 110-140 mg.

In a preferred but non-exclusive embodiment, the compound mentioned above may have a resistance to abrasion according to the UNI EN ISO 5470-1 standard in terms of weight loss of the layer, per se known method, of 110-140 mg.

In addition, the compound may have a specific weight according to the EN ISO 1183-1 standard between 1.14 g/cc and 1.33 g/cc, more preferably between 1.16 g/cc and 1.31 g/cc.

In a preferred but non-exclusive embodiment, the compound may have a specific weight according to the EN ISO 1183-1 standard between 1.16 g/cc and 1.31 g/cc.

It is clear that the hardness and resistance to abrasion values reported above, between 51 Sh A and 89 Sh A and between 100-150 mg, may contribute to conferring the particular soft touch effect to the compound, while a specific weight value between 1.14 g/cc and 1.33 g/cc may contribute to the lightness of the latter.

In a further preferred but not exclusive embodiment, the compound mentioned above may have a Shore A hardness measured according to the UNI EN ISO 868 standard comprised between 60 Sh A and 75 Sh A and a resistance to abrasion according to the UNI EN ISO 5470-1 standard in terms of weight loss of the layer, per se known method, of 110-140 mg.

Such values may allow to maximise the soft touch effect of the compound.

Furthermore, should the components mentioned above (A1) and (A2) be present in the compound in a mutual ratio 1:1, the soft touch effect may be maximised further.

Following this example, the compound may have Shore A hardness and resistance to abrasion values respectively between 51 Sh A and 89 Sh A and 100-150 mg and the components (A1) e (A2) may be present therein in a mutual ratio of 1:1 so as to have a soft touch effect.

On the other hand, the compound may have Shore A hardness and resistance to abrasion values respectively between 60 Sh A and 75 Sh A and 110-140 mg and the components (A1) e (A2) may be present therein in a mutual ratio of 1:1 to obtain an excellent soft touch effect for example as in the samples B, T, U of the example mentioned below 1.

In addition, the compound according to the invention may have an ultimate tensile strength value measured according to the ISO 527 standard between 11 and 18 Mpa.

Such data shows excellent mechanical properties of the compound, in particular in terms of ultimate tensile strength.

Furthermore, it is clear that the data mentioned above relating to hardness, resistance to abrasion, specific weight and ultimate tensile strength may equally refer to any layer of the flexible or spiralled hose obtained using the compound mentioned above, same case applying to a monolayer flexible or spiralled hose made using such compound.

In particular, the layer in question may be the outermost layer of the hose, which can be grasped by the user.

In this manner, the user may recognise the particular soft touch effect.

Furthermore, it is clear that such characteristics may be obtained thanks to the peculiar formulation according to the invention, as well as the presence of PVC having two different K factor values as well as described above.

According to a further aspect of the invention, the flexible and/or spiralled hoses according to the same may be useful for transporting any fluid, in particular any liquid.

In particular, the hose may be an irrigation hose or garden hose for the transportation of drinking water, while the spiralled hose may be a swimming pool hose for the transportation of water in swimming pool or SPA facilities.

The flexible hose of the present invention may include one or more layers and it may be reinforced or not. In case of multilayer hoses, at least the outer layer which can be grasped by the user may be obtained in the compound described above.

For example, the hose 1 may include an inner layer 3 in contact with the fluid to be transported, an outer layer 2 which can be grasped by a user and one or more reinforcement layers 4.

Preferably, the outer layer 2 may be obtained with the compound according to the invention.

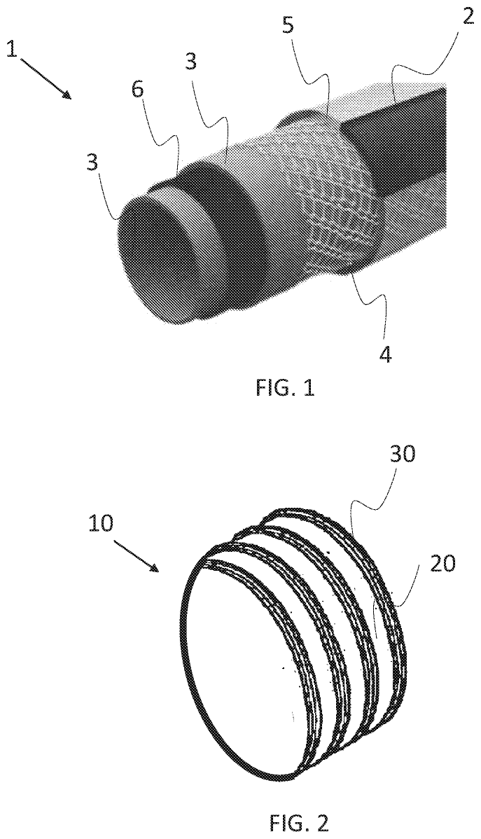

In a preferred but non-exclusive embodiment, the hose 1, whose portion is particularly shown in FIG. 1, may further include a covering layer 5 interposed between the reinforcement 4 and the outer 2 layer.

In this case, the latter may be a thin skin with thickness comprised between 0.1 mm and 0.6 mm.

In the preferred but non-exclusive embodiment shown in FIG. 1, the hose 1 may include a film 6 obtained in the inner layer 3 in a per se known manner, with anti-algae function.

Therefore, such film 6 may have the typical black colour or similar colour shades.

On the other hand, the spiralled hose 10 according to the present invention, whose portion is for example shown in FIG. 2, may include a main body 20 with at least one layer made of the compound described above and at least one reinforcement spiral 30 embedded in the main body 20.

In a per se known manner, the spiralled hose 10 may be made by extruding a webbing having a core made of a first polymeric material, for example rigid PVC, and a shell with at least one layer of the compound mentioned above.

Subsequently, in a per se known manner, the webbing may be spiral-wound on a spindle by joining the side walls thereof, so that the core forms the reinforcement spiral and the shell forms the main body.

Both in the case of the flexible hose 1 and of the spiralled hose 10, upon extrusion the compound mentioned above can be in granules, which may be prepared by means of the steps of:
mixing components (A) to (E) at at least one first predetermined temperature;
heating the mixture at a second predetermined temperature, preferably 140° C.;
cooling of the mixture to allow the formation of the granules;
extrusion of the granules of the compound, at a temperature range comprised between 155° C. and 185° C.

In particular, during the mixing step, the plasticising agent (B) may be added in progressive proportions: ⅓ of the plasticising agent (B) at at least 40° C. and the remaining ⅔ at temperatures comprised between 80° C. and 100° C.

The invention will be described in greater detail with reference to the following examples which, in any case, shall not be deemed to limit the scope of protection of the invention.

### EXAMPLES

### Example 1—Preparation of Samples

In order to evaluate the physical properties of the compound mentioned above, various samples were prepared, as specified below. The following raw materials were used:
(A) PVC matrix:
   PVC S 100 marketed by VINNOLIT® having a K factor measured according to the ISO 1628-2 standard of 100;
   PVC S4170 marketed by VINNOLIT® having a K factor measured according to the ISO 1628-2 standard of 70;
(B) plasticising agent: DOTP Eastman 168™ non-phthalate plasticizer marketed by EASTMAN;
(C) stabilising agent: Ca—Zn stabiliser marketed by TITANSTUC and ONE-PACK 1;
(D) co-stabilising agent: Epoxidized soybean oil Kimasol DB marketed by AMIK PLASTIFICANTI SRL;
(E) additive: Calcium carbonate Omyacarb® 2T-AV marketed by Omya.

The samples were prepared using a Brabender mixer, per se known.

Table 1 shows samples obtained with a formulation of the compound using the raw materials mentioned above, in which the various components are present in the compound in amounts according to the invention (samples according to the invention A, B, C, L, M, N, O, P, Q, R, S, T, U) or in amounts not according to the invention (comparative samples D, E). The values % of the various components relate to the total weight of the mixture.

TABLE 1

| | COMP. | COMP. | COMP. | COMP. | COMP. | COMP. |
|---|---|---|---|---|---|---|
| SAMPLE | A1 (%) | A2 (%) | B (%) | C (%) | D (%) | E (%) |
| A | 27.00 | 27.00 | 34.00 | 0.55 | 1.85 | 9.60 |
| B | 30.00 | 30.00 | 37.00 | 0.70 | 2.30 | 0.00 |
| C | 25.00 | 25.00 | 45.00 | 0.75 | 2.50 | 1.75 |
| D | 32.00 | 32.00 | 17.5 | 1.20 | 2.30 | 15.00 |
| E | 19.00 | 19.00 | 29.00 | 0.40 | 1.60 | 31.00 |
| L | 26.50 | 26.50 | 42.70 | 0.60 | 3.70 | 0.00 |
| M | 27.70 | 27.87 | 40.25 | 0.80 | 3.38 | 0.00 |
| N | 27.18 | 33.22 | 35.00 | 0.97 | 3.63 | 0.00 |
| O | 31.30 | 31.30 | 32.60 | 0.95 | 3.85 | 0.00 |
| P | 35.75 | 29.25 | 30.13 | 0.97 | 3.90 | 0.00 |
| Q | 34.65 | 34.65 | 26.26 | 0.97 | 3.47 | 0.00 |
| R | 28.70 | 28.70 | 33.77 | 0.80 | 2.87 | 5.16 |
| S | 31.01 | 23.39 | 42.86 | 0.57 | 2.17 | 0.00 |
| T | 28.86 | 28.86 | 39.36 | 0.61 | 2.31 | 0.00 |
| U | 29.93 | 29.93 | 37.11 | 0.64 | 2.39 | 0.00 |

Therefore, besides the comparative samples D and E mentioned above, there were prepared some comparative samples with the following formulations:

### Sample F:

53% by weight of PVC S 100 marketed by VINNOLIT® having a K factor measured according to the ISO 1628-2 standard of 100;
43.5% by weight of the plasticiser DOTP Eastman 168™ non-phthalate plasticizer marketed by EASTMAN;
0.85% by weight of the stabiliser Ca—Zn marketed by TITANSTUC and ONE-PACK 1;
2.65% by weight of the epoxidized soybean oil co-stabiliser Kimasol DB marketed by AMIK PLASTIFICANTI SRL;
0% by weight of the Calcium carbonate additive Omyacarb® 2T-AV marketed by Omya.

### Sample G:

52.78% BY weight of PVC S4170 marketed by VINNOLIT® having a K factor measured according to the ISO 1628-2 standard of 70;
43.80% by weight of the plasticiser DOTP Eastman 168™ non-phthalate plasticizer marketed by EASTMAN;
0.79% by weight of the stabiliser Ca—Zn marketed by TITANSTUC and ONE-PACK 1;
2.63% by weight of the epoxidized soybean oil co-stabiliser Kimasol DB marketed by AMIK PLASTIFICANTI SRL;
0% by weight of the Calcium carbonate additive Omyacarb® 2T-AV marketed by Omya.

Lastly, the rubber samples below were taken into account:

SAMPLE H: NBR Versilon™ Nitrile rubber sample marketed by Saint-Gobain Performance Plastics;

SAMPLE I: SBR Premium SBR Rubber Sheet AA715 rubber sample marketed by BRP Manufacturing Company.

### Example 2—Physical Properties Test at Room Temperature

For each of the samples A-U reported in Example 1, there were measured the hardness according to the UNI EN ISO 868 standard, resistance to abrasion as the weight loss of the layer according to the UNI EN ISO 5470-1 standard and the specific weight according to the EN ISO 1183-1 standard.

The results of such measurements are shown in Table 2, in which the average value of the values measured on 5 specimens for each of the samples mentioned above are reported.

TABLE 2

| | | SPECIFIC | |
|---|---|---|---|
| | HARDNESS | WEIGHT | RESISTANCE TO |
| SAMPLE | (Sh A) | (g/cc) | ABRASION (mg) |
| A | 65 | 1.270 | 135.6 |
| B | 70 | 1.198 | 127.3 |
| C | 60 | 1.173 | 140.0 |
| D | 92 | 1.359 | 152.0 |
| E | 66 | 1.430 | 155.3 |
| F | 60 | 1.170 | 161.2 |
| G | 62 | 1.170 | 221.5 |
| H | 65 | 1.350 | 125.4 |
| I | 70 | 1.500 | 134.9 |
| L | 60 | 1.168 | 141.3 |
| M | 65 | 1.180 | 138.7 |
| N | 74 | 1.201 | 122.6 |
| O | 78 | 1.211 | 118.9 |
| P | 82 | 1.221 | 115.8 |
| Q | 88 | 1.241 | 111.6 |
| R | 74 | 1.237 | 134.9 |
| S | 62 | 1.175 | 139.8 |
| T | 68 | 1.189 | 132.6 |
| U | 72 | 1.198 | 125.9 |

This table shows that the samples A, B, C, L, M, N, O, P, Q R, S, T, U all having two types of PVC and with values of all components (A-E) falling within the ranges according to claim 1 and, including, the samples A, B, C, M, N, R, S, T, U having a hardness value between 60 Sh A and 75 Sh A, as well as a resistance to abrasion value between 110-140 mg, have hardness and resistance to abrasion values comparable to samples H and I and therefore show a silkiness and flowability comparable to the latter.

In particular, if compared with samples F and G, the samples A, B, C, L, M, N, O, P, Q, R, S, T, U show a greater resistance to abrasion specifically due to the flowability of the surface of the sample which results in a reduced weight loss of the layer of the specimen during the test.

In addition, the samples B, T, U, having a ratio between the components A1 and A2 of 1:1 have hardness and resistance to abrasion values that can be completely superimposed with those of sampled H and I.

On the other hand, the samples A, B, C, L, M, N, O, P, Q, R, S, T, U have a specific weight markedly lower than samples H and I, as well as comparable to samples F and G.

### Example 3—Mechanical Properties Test: Ultimate Tensile Strength

For each of samples A-U reported in example 1, the ultimate tensile strength values were measured according to the ISO 527 standard.

The results of such measurements are shown in Table 3, in which the average value of the values measured on 5 specimens for each of the samples mentioned above are reported.

TABLE 3

| | ULTIMATE TENSILE |
|---|---|
| SAMPLE | STRENGTH (MPa) |
| A | 13.0 |
| B | 16.0 |
| C | 12.0 |
| D | 10.0 |
| E | 10.0 |
| F | 11.0 |
| G | 12.2 |
| H | 6.0 |
| I | 3.0 |
| L | 12 |
| M | 14 |
| N | 16 |
| O | 16 |
| P | 17 |
| Q | 18 |
| R | 15 |
| S | 13 |
| T | 15 |
| U | 15 |

This table shows that samples A, B, C, L, M, N, O, P, Q, R, S, T, U have ultimate tensile strength values comparable to those of samples F and G and markedly higher than samples H and I.

Therefore, the compound according to the invention shows to have excellent mechanical properties in terms of ultimate tensile strength.

1.-15. (canceled)

16. A method of manufacturing a hose, comprising:
extruding the hose to have a first layer,
wherein the first layer is made from a plasticized thermoplastic PVC compound comprising:
(A) a suspended PVC matrix comprising:
(A1) 20-40% by weight of a PVC having a K factor greater than 95 when measured according to DIN EN ISO 1628-2; and
(A2) 20-40% by weight of the PVC having the K factor comprised between 65 and 80 when measured according to the DIN EN ISO 1628-2 standard;
(B) 18%-45% by weight of at least one plasticizing agent;
(C) 0.5%-1% by weight of at least one stabilizing agent;
(D) 1.5%-4% by weight of at least one co-stabilizing agent; and
(E) 0%-10% by weight of at least one additive;
wherein weight percentages of components (A)-(E) are calculated with respect to a total weight of the plasticized thermoplastic PVC compound, and
wherein a sum of the components (A)-(E) is 100%.

17. The method according to claim 16, wherein the at least one plasticizing agent (B) is selected from the group consisting of DINP, DOTP, TOTM, DIDP, polymeric plasticizers, DOA, DEHA, DIDA, DINCh, vegetal plasticizers, epoxidized methyl esters, or a mixture of two or more thereof.

18. The method according to claim 16, wherein the plasticized thermoplastic PVC compound has a Shore A hardness measured comprised between 51 Sh A and 89 Sh A when measured according to UNI EN ISO 868 standard.

19. The method according to claim 16, wherein the plasticized thermoplastic PVC compound has a value of abrasion resistance between 100 and 150 mg when measured according to UNI EN ISO 5470-1 standard.

20. The method according to claim 16, wherein the plasticized thermoplastic PVC compound has a specific weight between 1.14 and 1.33 g/cc when measured according to the EN ISO 1183-1 standard.

21. The method according to claim 16, wherein the plasticized thermoplastic PVC compound has a Shore A hardness comprised between 60 Sh A and 75 Sh A when measured according to UNI EN ISO 868 standard and an abrasion resistance value between 110 and 140 mg when measured according to UNI EN ISO 5470-1 standard.

22. The method according to claim 16, wherein the PVC having a K factor greater than 95 when measured according to DIN EN ISO 1628-2 (A1) and the PVC having a K factor comprised between 65 and 80 when measured according to DIN EN ISO 1628-2 standard (A2) are present in the suspended PVC matrix in a ratio of 1:1.

23. The method according to claim 16, wherein the at least one additive is 0.1%-10% by weight

24. The method according to claim 16, wherein, in the suspended PVC matrix:
(A1) the 20-40% by weight of the PVC having the K factor greater than 95 when measured according to the DIN EN ISO 1628-2 standard has the K factor greater than 98; and
(A2) the 20-40% by weight of the PVC having the K factor comprises between 65 and 80 when measured according to the DIN EN ISO 1628-2 standard has the K factor between 70 and 75.

25. The method according to claim 16, wherein the first layer is superimposed on a second layer.

26. The method according to claim 25, further comprising a third layer interposed between the first layer and the second layer, the first layer having a thickness of 0.1-0.6 mm.

27. The method according to claim 16,
wherein the first layer is configured as a shell;
further comprising the step of providing a second layer a configured as a webbing made of a first polymeric material,
wherein the webbing is spiral wound on a spindle and adjoined to the first layer to form a spiraled hose.

28. The method according to claim 16, further comprising the step of providing the plasticized PVC compound for extrusion as granules prepared by:
mixing the components (A)-(E) at least one first predetermined temperature to develop a mixture;
heating the mixture at a second predetermined temperature;
cooling the mixture; and
extruding the cooled mixture to obtain the granules.

29. A flexible hose comprising:
a first layer; and
a second layer,
wherein the first layer is made from a plasticized thermoplastic PVC compound comprising:
(A) a suspended PVC matrix comprising:
(A1) 20-40% by weight of a PVC having a K factor greater than 95 when measured according to DIN EN ISO 1628-2; and
(A2) 20-40% by weight of the PVC having the K factor comprised between 65 and 80 when measured according to the DIN EN ISO 1628-2 standard;
(B) 18%-45% by weight of at least one plasticizing agent;
(C) 0.5%-1% by weight of at least one stabilizing agent;
(D) 1.5%-4% by weight of at least one co-stabilizing agent; and
(E) 0%-10% by weight of at least one additive;
wherein weight percentages of components (A)-(E) are calculated with respect to a total weight of the plasticized thermoplastic PVC compound, and
wherein a sum of the components (A)-(E) is 100%.

30. The flexible hose according to claim 29,
wherein the first layer is an outer layer positioned so as to be grasped by a user,
wherein the second layer is an inner layer positioned to be in contact with a fluid to be transported by the flexible hose,
further comprising a textile reinforcement layer interposed between the first layer and the second layer.

31. The flexible hose according to claim 30, further comprising a third layer interposed between the textile reinforcement layer and the first layer, the first layer having a thickness of 0.1-0.6 mm.

32. A spiraled hose comprising:
a main body having at least one layer made from a plasticized thermoplastic PVC compound that comprises:
(A) a suspended PVC matrix comprising:
(A1) 20-40% by weight of a PVC having a K factor greater than 95 when measured according to DIN EN ISO 1628-2; and
(A2) 20-40% by weight of the PVC having the K factor comprised between 65 and 80 when measured according to the DIN EN ISO 1628-2 standard;
(B) 18%-45% by weight of at least one plasticizing agent;
(C) 0.5%-1% by weight of at least one stabilizing agent;
(D) 1.5%-4% by weight of at least one co-stabilizing agent; and
(E) 0%-10% by weight of at least one additive;
wherein weight percentages of components (A)-(E) are calculated with respect to a total weight of the plasticized thermoplastic PVC compound, and
wherein a sum of the components (A)-(E) is 100%; and
at least one reinforcement spiral embedded in the main body.
